(19) United States
(12) Patent Application Publication
(10) Pub. No.: US 2013/0046708 A1
(43) Pub. Date: Feb. 21, 2013

(54) SYSTEM AND METHOD FOR USING METADATA TO FACILITATE THE DISTRIBUTION OF GOODS THROUGH A SUPPLY CHAIN

(71) Applicants: Justin Griep, Denver, CO (US); Sweeni Ponoth, Carrolton, TX (US)

(72) Inventors: Justin Griep, Denver, CO (US); Sweeni Ponoth, Carrolton, TX (US)

(73) Assignee: DEMANDPOINT INC., Englewood, CO (US)

(21) Appl. No.: 13/588,858

(22) Filed: Aug. 17, 2012

Related U.S. Application Data
(60) Provisional application No. 61/524,622, filed on Aug. 17, 2011.

(51) Int. Cl. G06Q 10/06

(52) U.S. Cl. 705/348

(57) ABSTRACT

A system and method for supply chain management that may include a product hierarchy, a location hierarchy, and/or a time hierarchy; metadata that describes data about the system, located throughout the system; and a model that defines the structure of the metadata, wherein the system may be operable to control distribution of products throughout the supply chain.

### CROSS-REFERENCE TO RELATED APPLICATIONS

This application claims the benefit of U.S. Provisional Patent Application Ser. No. 61/524,622, filed Aug. 17, 2011, entitled “Meta-Data Driven Supply Chain Planning Architecture” [Attorney Docket 1110-00004], the entire disclosure of which application is hereby incorporated by reference herein.

### BACKGROUND OF THE INVENTION

This application is directed in general to demand and/or supply planning and in particular to an integrated solution for planning applicable to one or more stages of a supply chain.

Currently, there are many different planning systems on the market for various segments of the overall supply chain. Almost all are dedicated to specialized areas of the supply chain including sales planning, forecasting, distribution planning, inventory planning, transportation planning, and manufacturing planning

Vendors have ended up creating modules for each business function, often without significant reuse of a common architecture for planning. This has been driven by market forces where vendors chose specific planning functions and have added new ones as customers have asked for new types of planning Each of these business functions has some commonality and then major differences in requirements.

In addition, while many planning systems store some configuration data, there is still a heavy reliance on software code to drive planning processes and user interfaces. This code and the data model used end up being different for different modules. Making changes for specific requirements or generating an entirely new planning type for a particular application generally requires new code and a new data model.

Due to the reliance on software code and the disparate modules that vendors offer, many challenges arise for the vendor and customers of the vendor. These challenges may include the following. (a) Programming may be required to make changes to planning processes and user interfaces, which are expensive, time consuming, and which may lead to the use of code that is unsupported by the software vendor. (b) There is often not a consistent interaction and set of processes across all of the supply chain planning functions, thereby leading to disintegrated business processes and additional maintenance and training expenses. (c) It may be difficult to create new planning solutions for a business's specific needs, which may lead businesses to try to adjust system configurations to available software, instead of adjusting the software to suit the needs of the business. (d) Third Parties may confront a more significant barrier to adding new functionality to the platform while taking advantage of common functionality, which reduces choice in capability and competitive advantage for client businesses.

Accordingly, there is a need for improved systems and methods for providing functionality to supply chain planning

### SUMMARY OF THE INVENTION

According to one aspect, a supply chain management system may include a product hierarchy, a location hierarchy, and/or a time hierarchy, metadata that describes data about the system, located throughout the system, and a model that defines the structure of the metadata, the system being operable to control distribution of products throughout the supply chain.

According to another aspect, a supply chain management system may include a product hierarchy, a location hierarchy, and/or a time hierarchy, metadata that describes data about the system, located throughout the system, and a model that defines the structure of the metadata, the system being operable to control manufacturing of products for distribution through the supply chain.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a block diagram showing a high level representation of a metadata model in accordance with one embodiment of the present invention;

FIG. 2 is a block diagram showing a product hierarchy organized by business unit, by type of product, and by the final product actually sold, in accordance with an embodiment of the present invention;

FIG. 3 is a block diagram showing a distribution network having a first level corresponding to a retail level of a location hierarchy (which may be an aggregation for a retailer, not necessarily a single physical location), a second level corresponding to regional distribution centers, and actual retail outlets which receive product from the distribution centers (for which some specific named examples are provided), in accordance with an embodiment of the present invention;

FIG. 4 is a data table showing examples of planning line definitions for the planning function forecast planning, in accordance with an embodiment of the present invention;

FIG. 5 is a block diagram showing work flow and status transitions for the life cycle of a supply chain plan in accordance with an embodiment of the present invention;

FIG. 6 is a screen shot of a flexible and configurable planning screen that includes screen controls based on the planning screens configuration, in accordance with an embodiment of the present invention;

FIG. 7 is a screen shot of a charting control data display and input mechanism that is configured using metadata, in accordance with an embodiment of the present invention;

FIGS. 8A and 8B are screen shots of business intelligence data in accordance with an embodiment of the present invention; and

FIG. 9 is a block diagram showing a system and method for acquiring and updating software for enabling supply chain planning, in accordance with an embodiment of the present invention;

FIG. 10 is a block diagram of a data processing system useable in conjunction with an embodiment of the present invention; and

FIG. 11 is a data table showing examples of planning line operations to define various data loads and calculations, in accordance with an embodiment of the present invention.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to phrases such as “one embodiment” or “an embodiment” means that a particular feature, structure or characteristic described in connection with the embodiment is included in at least one embodiment of the invention. The appearances of phrases such as “in one embodiment” or “in an embodiment” in various places in the specification do not necessarily all refer to the same embodiment.

We have designed a solution for planning across the various business functions related to the supply chain from raw goods all the way through to consumer purchasing of products at the tail end of the supply chain. A supply chain may include varied functions and distinct requirements for each type of planning and supply chain segment. For example, a supply chain may include sales, purchasing, distribution, and manufacturing. We have designed a system that is generalized enough to handle the variations between these different types of planning, but that still uses a common architecture. According to one aspect, a system as disclosed herein may be operable to control the production of goods and the distribution of the produced goods through a supply chain. Control over the production of goods may result when the quantity demanded of a particular product exceeds all available inventory, and newly manufactured units of the product concerned are needed. The movement of physical goods to and through various physical locations within a supply chain, from distribution centers to final consumer retail outlets is addressed throughout this disclosure. Thus, one or more embodiments of the methods disclosed herein may be tied to the physical product being shipped, and/or to the physical locations the products are shipped from, shipped to, and stored within.

For instance, if a quantity of product needs to be shipped from location A to location B in one day, and locations A and B are separated by two thousand miles, a method herein may require that an air cargo service travel be used, instead of ground shipping. Moreover, the selection of the category of product to be shipped may be effected by one or more embodiments of the system and method disclosed herein. Thus, the selection of product categories from inventory may operate to tie one or more methods herein to the physical goods being selected, removed from inventory, and shipped to a designated destination with the pertinent supply chain. Further, the selection, scheduling, and/or routing of the shipping mechanism (whether on land, sear, or in the air) employed to convey the selected physical goods to a designated destination may be controlled by one more of the methods disclosed herein, which thereby may tie the relevant method embodiments to shipping mechanism in addition to the goods being transported.

To accomplish this, the common elements of meta-data (configuration of the system), planning data (stored planning data), and functionality (both business process and user interface) of all the planning systems have been identified and consolidated into an embodiment of the present invention. An embodiment of the solution discussed herein also assumes that each planning system will have its own software functionality, but that it will use this common core architecture.

### Solution to Address the Problems

We have worked to determine the common capabilities useable across a range of planning functions in the supply chain and have designed a meta-data model to support these capabilities that also drives business processes, analysis, and user interface components. This solution also assumes that data describing supply chain elements and past performance of the supply chain, and its constituent elements, is available to the application(s) running herein.

This approach leads to resolving or reducing the impact of the problems with the state of the art in the following ways. (a) The amount of programming effort is preferably greatly reduced by including common functionality at various points in the supply chain, driven by a meta-data model that requires a lower level of technical expertise to change the behavior and functionality of a planning system. This then reduces the expense to the vendor and customer for customization and building new planning types. (b) Because the system has a common set of functionality and user interface components, operation of the system by users, business functionality, and integration between the different planning types is consistent. (c) The reduced requirements in resource expertise and time to custom configure solutions leads to planning systems that better meet customer's specific business requirements. (d) Third party vendors that want to add new modules and functionality have the advantage working with a common core architecture that can cover many requirements of a planning system. Thus the vendors can focus on trying unique functionality required for their vision of a new planning type.

The solution can be thought of in two main parts, the first being the planning Meta-Data model that is configuration and, second, the Planning System Functionality that is the software that utilizes the meta-data model to execute. The next two major sections are directed to these two parts, respectively.

### Beneficial Features of the System

The following summarizes differences between embodiments of the present invention and the existing art.

1. A supply chain planning system driven by the meta-data to describe a planning function may include (see Planning Functions, Planning Hierarchies, and Planning Lines): (a) a planning function; (b) a product hierarchy; (c) a location hierarchy; (d) a time hierarchy; and/or (e) planning lines.
2. Various combinations of the metadata in item one above may be used, with additional elements defined in the conceptual model (see the Conceptual Meta-Model and related sections for the additional elements).
3. The planning system functionality useful for executing a solution based on the metadata in various combinations of functionality may include the following (also see the Planning System Functionality section):
a. Managing the meta-data model;
b. Providing functionality to build and manage plans based on the meta-data model;
c. Automatically implementing user interface from the meta-data model;
d. Providing business intelligence from the plan data and meta-data model; and
e. Allowing for extensibility with plan modules that interact with the meta-data model and planning system.

### Planning Meta-Data Model: Meta-Data and the Data Model

The Planning Meta-Data Model is a data structure that contains the common configuration information for planning systems in the Demand Flow Platform. Meta-data is the data about the data in a system and the model is the structure of this meta-data. This section will describe the elements and relationships of the meta-data model.

By creating this configuration, common software functionality can consume the configuration to operate. This will be described in the next major section on Planning Functionality.

### Conceptual Meta-Data Model

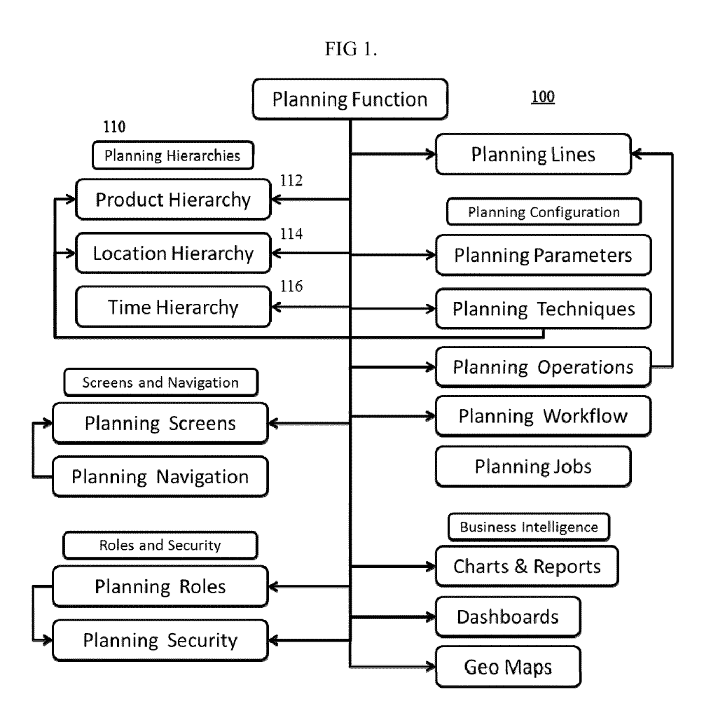

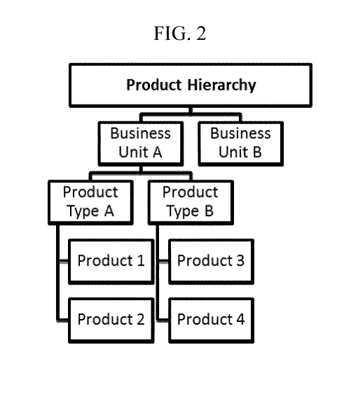

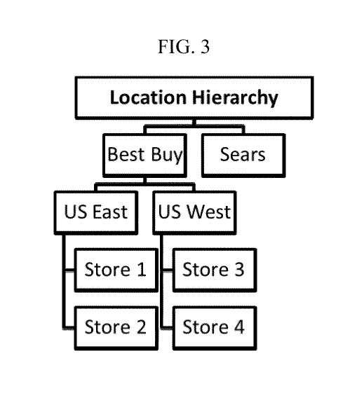

FIG. 1 is a high level representation of the meta-data model. Each of the elements in this model is conceptual and may include more than one table and have multiple fields for each table. Each of these elements is described in detail in the following sections.

### Planning Functions

Planning Functions are the root elements of the meta-data model and most of the other elements are related to a specific planning function. The planning function represents a planning type, as we have described planning types previously in this document. For each planning type we need a set of configuration data that is specific to that type and is represented by the planning function.

As examples, some of the current planning functions in the system are: (a) Forecasting future sales using statistical techniques; (b) Sales Planning—Coordinated sales planning by sales operations to commit to and plan for future sales orders; (c) Collaborative Planning and Forecasting—Shared forecasting and commitments to replenishment with distribution partners especially retailers; and/or (d) Distribution Planning—Planning for inventory and replenishment of inventory in a distribution network using an algorithm for calculating optimal decisions and inventory quantities.

### Planning Hierarchies

There are three dimensions—i.e. planning hierarchies 110—that are fundamental to any planning solution and the data stored for the plan. These are what is the item (product hierarchy 112), where is the item (location hierarchy 114), and when is this occurring (time hierarchy 116). Each of these dimensions typically has a lowest level of detail that can be a part number/SKU for a product, a location number for a location, and chronological unit such as days, hours, or other unit, as measurements of elapsed time. However, for planning purposes, we often need to work with higher levels of aggregation from the lowest level of detail. For example, for products we might have product categories. For locations, we may have common distribution centers; and for time we have weeks, months, etc.

The most valuable representation for these various levels is a hierarchy or hierarchical tree which is based on a child to parent relationship between the nodes representing a specific dimension. The leaf nodes of these hierarchical trees are typically the lowest level of detail. Nodes in a hierarchy can represent either an actual entity, such as a sold product or store location, or an abstract concept, such as a product category.

There are multiple uses for hierarchies and they can take many forms that are determined by the planning needs. Some examples of hierarchies follow. However, the variables used in modeling supply chains may employ hierarchies different from those listed below.

### Time Hierarchy

The time hierarchy 116 is typically based on the fiscal calendar of the primary entity using the planning function. The hierarchy of units of time used usually includes measures in the form of days, weeks, months, quarters, and years. The system may also then define which levels of the hierarchy are used as planning buckets. For example, a planner doing short-term and long-term planning together may want to plan for some number of weeks and then switch to a larger time bucket, such as months and then years. Each planning bucket is a discrete stored quantity for a particular parameter and a particular point in time.

### Hierarchy Attributes

Different levels of a hierarchy and the actual nodes in the tree can represent attributes of the product, location, or time. This enables the planning system to understand the meaning of a particular node and affect the behavior of the system and the data related.

### Some Examples of the Hierarchies Follow:

For product hierarchies in the apparel industry, we may have a level for style, followed by a level for color, and finally a level for size. The first two levels are higher-level category representations, and once we reach the final level of size, this represents an actual sold product.

For location hierarchies, we can describe the actual location that is represented and the type of location, such as store or retailer.

### Hierarchies for Plan Data

To store plan-specific data, we need all three dimensions, product, location, and time, such that one node from each of these trees represents a specific planning bucket that we plan with, and store the planning data for.

### Planning Lines

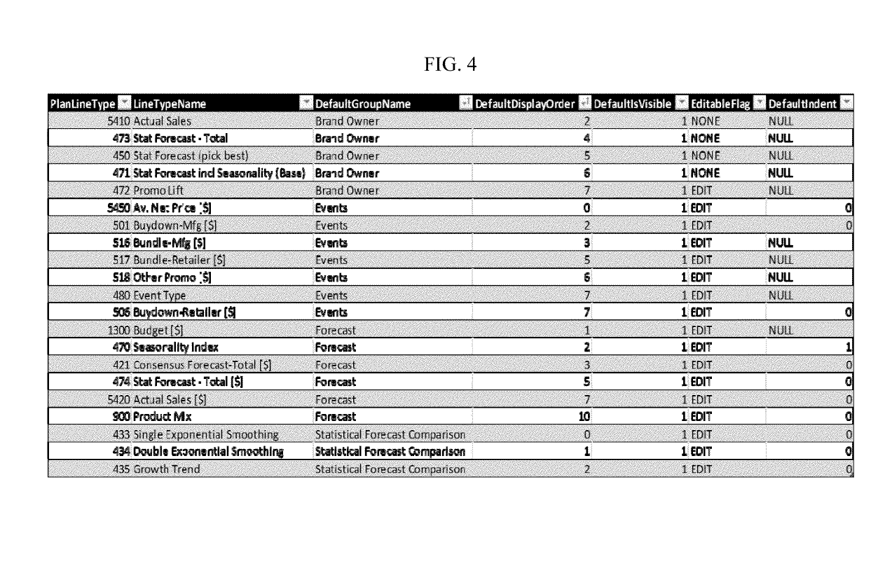

Planning Lines are the lines of a plan, which is easiest to think of as lines in a spreadsheet, where the user has a different type of information on each row of the spreadsheet and time is shown in columns. Each planning bucket, being a combination of a node from the product, location, and time hierarchies may have different data points that need to be stored. These data points become unique planning lines. FIG. 4 shows examples of planning line definitions for the planning function forecast planning

### Planning Function Specific Configuration

Each planning function will have its own needs with regard to specific configuration parameters to drive any underlying planning logic. One example of variation in planning functions is the contrast between distribution planning and forecast planning In distribution planning, the parameters will relate to the distribution network and what tactics to use in dealing with exceptions such as not having a large enough supply of a product. One setting may require prioritizing A-rated stores' inventories first. In forecast planning, the engine will need to know which statistical forecasting techniques to apply to which combinations of products and locations and the variable setting to use in the calculations.

### Planning Parameters

General parameters store values that affect the engine and are keyed with a name and then have a value of a specific type, such as date, floating point numbers, integer numbers, strings, and Boolean values. These are represented as name/value pairs that also have a definition for the allowed parameters. Parameters can be defined globally for a specific planning function or applied to a technique (as defined below). This flexibility allows for an unlimited set of parameters to be defined for any planning function.

### Planning Techniques

Planning Techniques are techniques implemented by the planning engine that apply to specific combinations of product and location nodes in the product and location hierarchies, respectively. This is useful for logic that will not apply to every part of a plan, but instead to these specific subsets of the plan. Each technique can be defined and then assigned to the product and location hierarchy nodes and have parameters (as defined in the previous section) that configure the technique.

The best example of this is the desire to use different statistical forecasting techniques for different locations in a distribution network and for different groups of products. This is useful when different stores sell different products and have different demand patterns. In this situation, different forecasting techniques are matched up for the various different stores that are more predictive of future demand in each of the stores.

### Planning Operations

Planning Operations are common functions that update data in the planning buckets based on meta-data to configure the inputs to these functions and order in which operations should execute. Planning Operations may operate in a manner similar to the formula functions in spreadsheets which indicate how data should be calculated for a data element and which data elements to use as inputs.

Planning Operations are sets of functions that can be used across the various planning functions, since many are common to the various functions. The most basic operations include copying, adding, subtracting, multiplying, and various aggregation functions. Also importantly, the planning system triggers these operations when appropriate, such as creating new plans or user's updating plans. The main categories of Planning Operations are detailed in the next sub-sections.

### Planning Line Loading

Plan Line Loading operations load data from an external data source in to a planning line's planning buckets. This is often loaded from the data mart, but can come from any other defined source. A simple example is loading historical sales order data into plan lines for review in planning, where the system will load for previous sales orders and aggregate in a given planning bucket based on the product and location combination for this planning bucket.

### Planning Line Calculation

Plan Line Calculation operations update data in a planning line with inputs from one or more plan lines for a particular combination of product and location nodes, and apply a specified calculation. For example, we may want to add a Base Forecast Line with a Promotional Forecast Line and insert this into a Total Forecast Line.

### Aggregation/Disaggregation/Reconciliation

Since the planning environment is based on a hierarchy, planning buckets at different levels of the hierarchy may affect buckets at a lower or higher level in the hierarchy tree. When these values are related, we have three types of operations that can handle these calculations. (1) Aggregation—where values of children are aggregated together to create higher level values, such as all products in a category adding up to the category level. (2) Disaggregation—where values from a parent are disaggregated down to the children in the hierarchy tree. This involves determining a method that best fits how values will be disaggregated. For example, we may want to disaggregate a forecast for a region of stores down to the individual stores, and we may use a ratio of the historical sales volumes for each store to the total volume for the region. (3) Reconciliation—which is a more complex process in which user intervention deals with differences in lower and higher level planning buckets to reconcile to a single set of values based on aggregation to the parent. Reconciliation may be used when plans are done at multiple levels with different techniques and there is a need to match for both top and bottom level plans. These operations are also defined by the planning line that is involved.

### Plan to Plan Operations

The operations discussed above are within a plan in a specific planning function. However, we also have cases in which plans need to be related to each other across planning functions and the values copied and translated from one plan to the other. These are Plan-to-Plan Operations. Typically, this is just a copy of planning bucket values from source plan's specific plan line to a destination plan's specific plan line. A good example of this is when a Distribution Plan needs a copy of the forecast from a Forecasting Plan. In this case, an operation is defined to enable providing a copy of a forecast from a forecasting plan to the distribution plan.

### Planning Screens and Navigation

A planning system needs to have screens and navigation to those screens. This architecture also supports this with meta-data to drive user interface controls that implement this functionality for users to interact with. Each screen has a definition and this includes the associated planning function and parameters that drive the behavior of the screen and the controls on the screen. Navigation is a menu system that implements a menu system with a hierarchy of menu items, and the information on the screen to be loaded when the menu is selected. Readers may review the section herein on “Plan User Interaction” for more information related to this meta-data in operation.

### Planning Roles and Security

Planning Roles and Security covers managing user access to data and functionality as well as the behavior of the system based on the logged-in user. Roles defined in the meta-data model define groups of users. The roles then have permissions that are assigned to the other various elements of the system defined in the meta-data model, including planning functions, planning line view, screens, and others.

### Planning Workflow

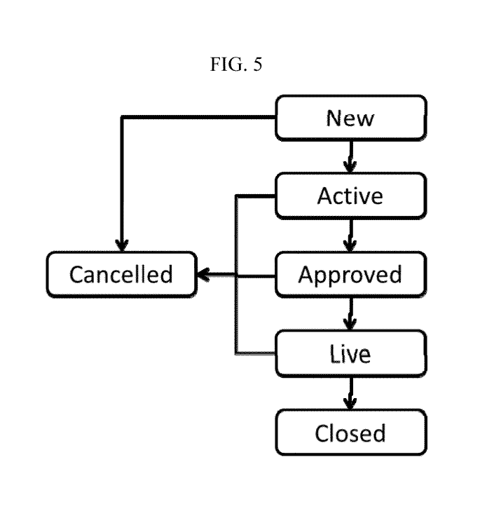

Building a plan in an organization often requires a business process workflow and a status as the plan moves through multiple statuses. In addition, this supports having multiple plans (called scenarios) in the system and choosing one plan to become the current live plan. The Workflow planning portion of the meta-data model defines the workflow states and the transitions between statuses. FIG. 5 shows a simple example of workflow and status transitions.

### Planning Jobs

Planning systems typically have long running processes that need to be managed. These include processes like ETL (extract, translate, and load), complex planning calculations, and other large volumes of data processing. Because of the long run times, jobs for these processes need to be scheduled or queued. This meta-data defines the jobs and parameters that are required for running the jobs. Jobs can also have dependencies where some jobs have to be executed before starting a specific job.

### Planning Business Intelligence

Business intelligence components can also be defined in the meta-data allowing planners to analyze and visualize data derived from the various plans in the planning systems. There are three types of meta-data elements that are defined for Planning Business Intelligence. Charts & Reports—which define which type of chart or report to display and the specific plan lines to display in combination and other specific parameters for the chart or report. Dashboards which may include combinations of charts and reports for a simultaneous display on the screen at one time using various layouts. Geographic Maps which may include configuration of planning data in combination with supply chain data in the data mart to create geographically mapped representations.

### Planning System Functionality

The Planning Meta-Data Model drives the planning system, but functionality is required to execute the planning system based on this configuration. This section covers this functionality.

### Meta-Data Model Management

Meta-data model components generally require that the planning system have functionality for editing the information in the model. This functionality preferably includes a user interface and data management for each component type. In addition, planning functions may require specific configuration capabilities for unique types of metadata that will be provided in that planning module.

### Plan Building and Management

Plans and the multiple scenarios of various plans are preferably created and managed through the process to a completed plan. The following functionality supports the entire lifecycle of a plan.

### Plan Data Storage

Each plan and scenario contains a copy of the default configuration that can then be modified to adjust the specific plan's operation. This includes a copy of the Planning Function Specific Configuration and the attached Planning Hierarchies (see the related sections for each).

Plan data storage consists of the data quantity values that are stored as unique data elements per the following: Plan; Plan Scenario; Product Hierarchy Node; Location Hierarchy Node; Planning Line; Time Bucket;

### Plan Building

This set of functionality supports the building of plans from creation of a plan through planning activities to a final plan. Here is a list of that basic functionality: Plan Creation—The initial creation of the plan and scenarios that includes the meta-data configuration and initial population of data loaded from external sources. Plan Scenario Copying—Copying one plan scenario to a new scenario to allow for what if planning and building multiple scenarios to arrive at a final plan. Plan Removal—Deletion of plans that are either no longer needed or expired in an archival process. Plan Workflow and Approval—The workflow for the status of plan scenarios and the eventual approval of a plan scenario to become the active or live plan. Editing Plan Data—The ability for planning users to edit the plans and the updates to the plan data to cause additional calculations as appropriate for the given changes. Role and Security Support—For the specific planning user that is logged in, enabling a system for protecting data and determining what the users is allowed to view and edit. Plan Operations & Jobs—There are many processes that must run as the planning process begins and progresses and must be handled by the system.

### Plan Operations & Job Execution

As the plan is generated and updated during the plan development process, coinciding events preferably cause specific functions be executed to calculate correct values and provide predicted values. A simple example is that if the user manually overrides forecast values, the other values that are dependent on the forecast, such as inventory levels, will require recalculation. These functions are discussed in detail in the Planning Techniques and Planning Operations sections above.

Some of these operations and data preparation in the data mart are longer running and require a job engine that can handle both scheduled jobs and jobs fired on demand by the users. This engine is based on the Planning Jobs meta-data described previously.

The engine needs to cover multiple types of calls to execute the various functions, including: SQL Statements or Stored Procedures; Extract, Translate, and Load Packages; and/or API Calls (to libraries of code including modules).

### Plan User Interaction

The user's interactions may be handled by a set of controls that operate using the meta-data model. The controls each have a specific purpose and some controls can contain other controls. The combination of these controls end up forming the core user interface for the planning system. Each of these controls needs to implement security as defined in Planning Users and Roles.

### Top Level Controls

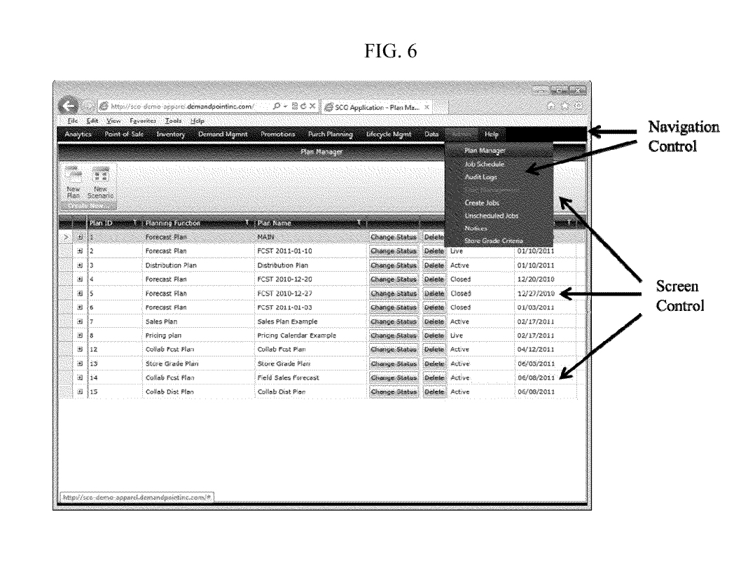

The top-level controls may include Navigation Control—Creates a menu system based on the Planning Navigation; and/or Screen Control—which creates a flexible and configurable planning screen that contains Screen Controls based on the Planning Screens configuration, as shown in FIG. 6.

### Screen Controls

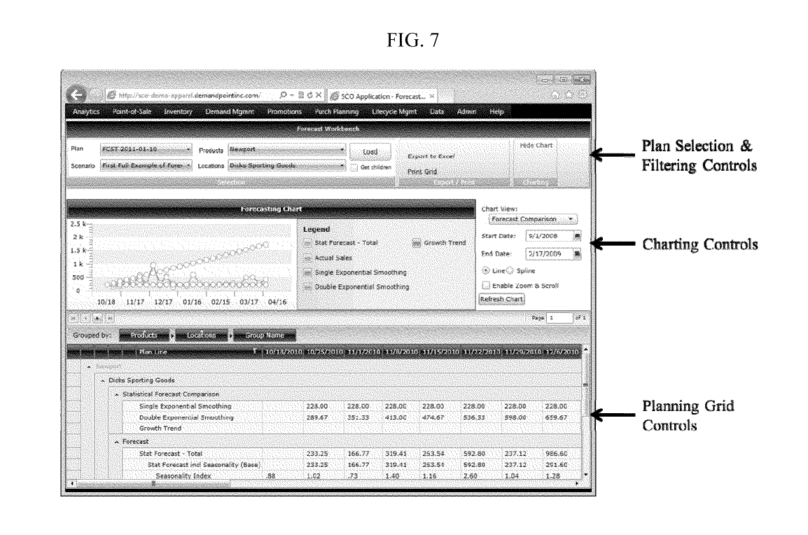

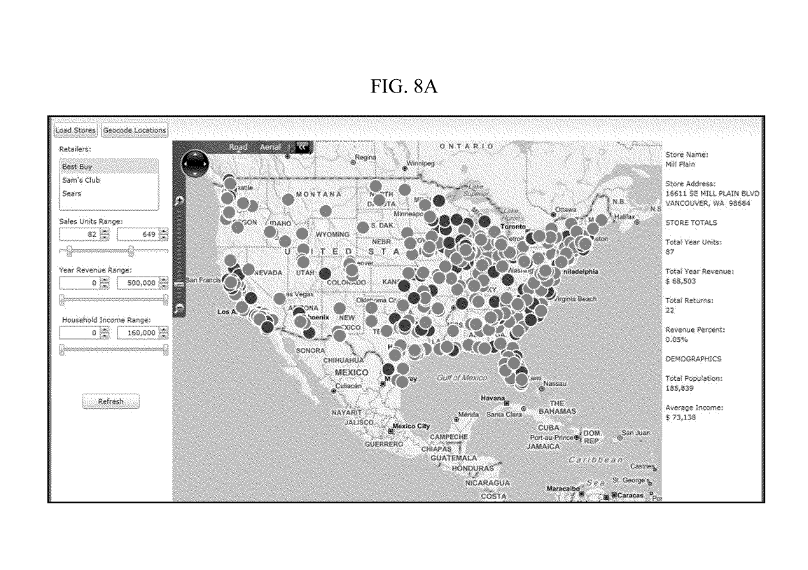

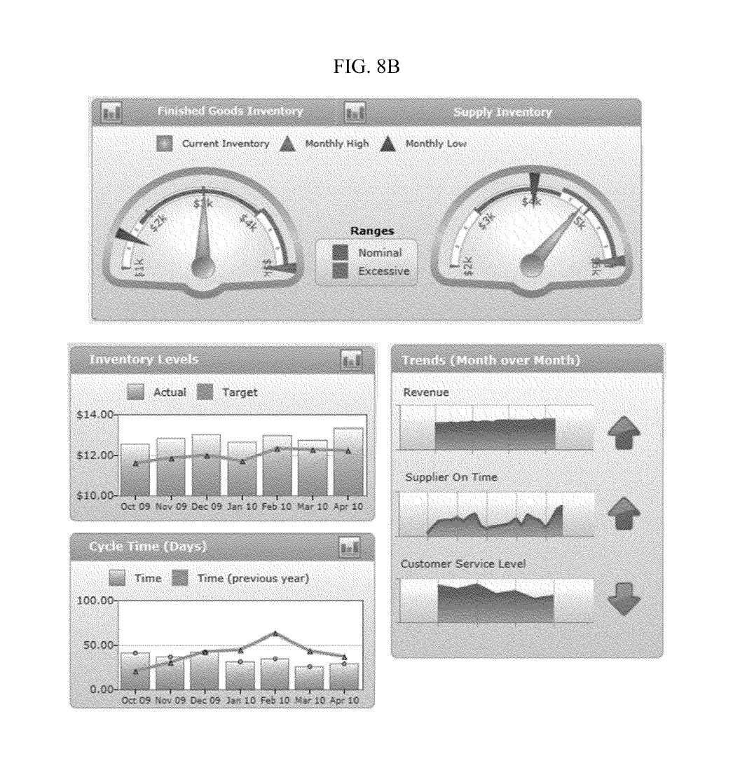

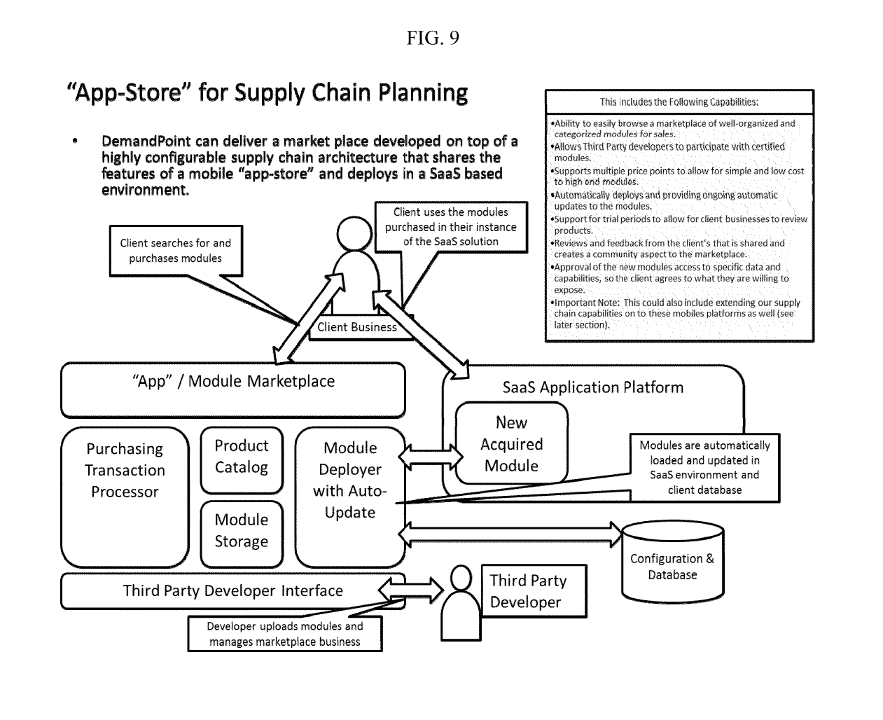

The screen controls may include plan selection and filtering controls which may allow the user to select specific plans and scenarios and select portions of the product and location hierarchies to view; Planning grid controls, which may lay out the planning data in a grid with extensive functionality for managing the grid, where the data is typical rows of plan lines and columns of buckets of time. This also has intelligence around how to update the planning data when edits are made. The screen controls may further include charting controls, that is, the ability to chart data directly on the planning screen and is configured by the chart's meta-data, an example of which is shown in FIG. 7.

### Business Intelligence

Meta-data also drives specific business intelligence views (as defined in the Planning Business Intelligence section). These include views of: reports; dashboards; and/or geographic maps.

### Plan Modules

Each Planning Function may have functionality that is not provided by the capabilities of the common architecture detailed herein. To cover this business logic, modules can be developed and integrated with the solution that utilize a common API for the Meta-Data Drive Supply Chain Planning Architecture and implement in code the additional features. Configuration can still be pulled for this specific functionality from the Planning Function Specific Configuration (see the related section above) which is flexible enough to support the applications contemplated herein.

Typically, a planning module will also have an internal planning engine that will apply one or more techniques to handle complex operations and calculations. For example the forecasting engine handles multiple statistical forecasting techniques.

The modules may also be developed by third parties, which will enrich the offering available for clients. This necessitates that modules development should allow for a rapid development process. Wizards and templates will guide the meta-data and software code creation.

### Plan Modules Marketplace

Plan modules developed for the planning system can also be offered on a marketplace that clients can easier access and procure new planning functionality. This will allow for a lower barrier to entry for new operational modules.

While some ERP and other planning system vendors provide an online listing of available modules, there is still significant interaction with the Third Party vendor and technical resources from the vendor or value-added service providers to fulfill the delivery of a new module. The mobile phone and tablet has shown a better model that reduces overhead to acquiring new modules or “apps” that can be automatically deployed and updated that can be applied to supply chain planning systems.

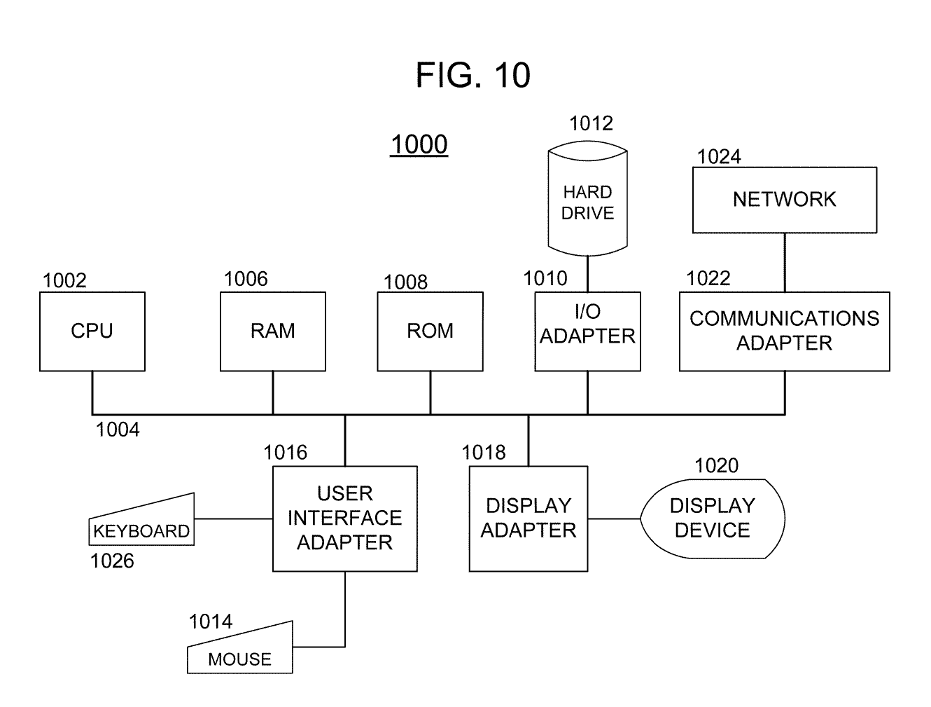

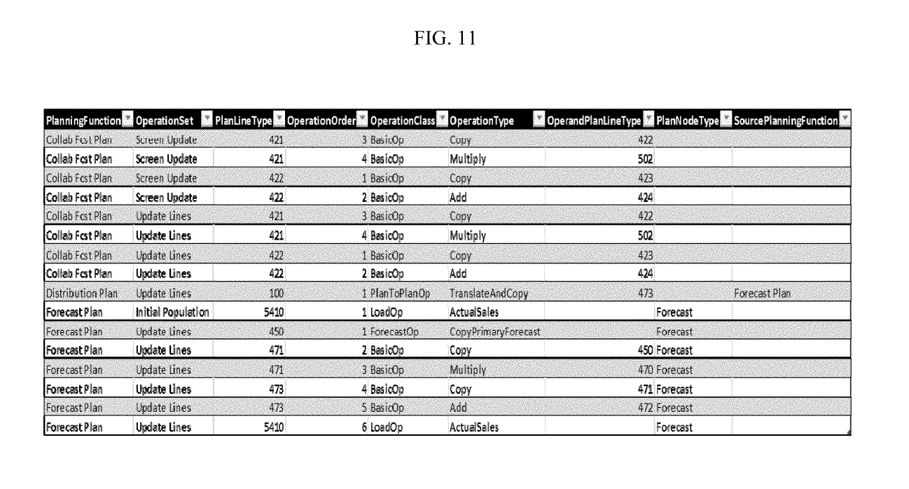

FIG. 10 is a block diagram of a computing system 1000 adaptable for use with one or more embodiments of the present invention. Central processing unit (CPU) 1002 may be coupled to bus 1004. In addition, bus 1004 may be coupled to random access memory (RAM) 1006, read only memory (ROM) 1008, input/output (I/O) adapter 1010, communications adapter 1022, user interface adapter 1006, and display adapter 1018. Computer system 1000 may be used for any of the computational, control, and/or planning functions described herein.

In an embodiment, RAM 1006 and/or ROM 1008 may hold user data, system data, and/or programs. I/O adapter 1010 may connect storage devices, such as hard drive 1012, a CD-ROM (not shown), or other mass storage device to computing system 1000. Communications adapter 1022 may couple computing system 1000 to a local, wide-area, or global network 1024. User interface adapter 1016 may couple user input devices, such as keyboard 1026, scanner 1028 and/or pointing device 1014, to computing system 1000. Moreover, display adapter 1018 may be driven by CPU 1002 to control the display on display device 1020. CPU 1002 may be any general purpose CPU.

It is noted that the methods and apparatus described thus far and/or described later in this document may be achieved utilizing any of the known technologies, such as standard digital circuitry, analog circuitry, any of the known processors that are operable to execute software and/or firmware programs, programmable digital devices or systems, programmable array logic devices, or any combination of the above. One or more embodiments of the invention may also be embodied in a software program for storage in a suitable storage medium and execution by a processing unit.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A system for supply chain management system comprising:
a product hierarchy;
a location hierarchy;
a time hierarchy;
metadata that describes data about the system, the metadata being stored on computer storage devices located throughout the system; and
a data model that defines the structure of the metadata, wherein the data model is a method operable to run on a computer system using data stored on one or more computer storage devices and operable to move products through a supply chain to achieve a target product distribution throughout said supply chain.
